(19) United States
(12) Patent Application Publication
(10) Pub. No.: US 2011/0154374 A1
(43) Pub. Date: Jun. 23, 2011

(54) APPARATUS AND METHOD FOR MANAGING CUSTOMIZED APPLICATION

(75) Inventors: Kyong-I KU, Seoul (KR); Won-Hyuk Choi, Daejeon (KR); Moon-Young Chung, Daejeon (KR); Won-Young Kim, Daejeon (KR); Sung-Jin Hur, Daejeon (KR)

(73) Assignee: Electronics and Telecommunications Research Institute, Daejeon (KR)

(21) Appl. No.: 12/970,438

(22) Filed: Dec. 16, 2010

(30) Foreign Application Priority Data
Dec. 18, 2009 (KR) 10-2009-0126724
Mar. 3, 2010 (KR) 10-2010-0018864

(51) Int. Cl. G06F 9/46

(52) U.S. Cl. 719/320

(57) ABSTRACT

Provided is a technology capable of efficiently managing various customized applications according to clients and providing security and efficiency in executing and editing the customized applications. An apparatus for managing customized applications according to an exemplary embodiment of the present invention, comprising: an application supplying unit generating the customized applications by combining a plurality of pre-stored application data according to client information; an application executing unit generatin a virtual executing environment to allow the customized applications to be executed in a server or virtual server on a client terminal and supplies the virtual executing environment to the client terminal; and a filtering unit controlling whether it permits one or more of the execution and edition of the customized applications according to the client information.

### CROSS REFERENCE TO RELATED APPLICATION

This application claims the benefit of Korean Patent Application No. 10-2009-0126724, filed on Dec. 18, 2009 and Korean Patent Application No. 10-2010-0018864, filed on Mar. 3, 2010, which is hereby incorporated by reference in its entirety into this application.

### BACKGROUND OF THE INVENTION

1. Field of the Invention

The present invention relates to a technology for managing applications customized according to clients or a group of specific clients. More particularly, the present invention relates to a technology for distributing customized applications to client terminals and generating, executing, and managing the customized applications in a server or virtual server on client. Further, the present invention relates to a technology for controlling whether customized applications can be executed and edited according to the right of clients.

2. Description of the Related Art

A demand for a technology capable of providing client customized computing environment at any locations or at any time by building a mobile computing environment similar to a desk top environment has increased. In the mobile personal computing environment, a technology for a function of distributing and managing software for each client is important.

There are mobile personal computing environment, virtual device, software apparatus technology, and technology capable of moving a client/server based software streaming technology to a mobile storage device, etc. The technology stores a host operating system (OS), a virtual machine, and various applications in a mobile storage device. When using a computer, which can be booted by the mobile storage device, various applications can be executed by using only one storage device.

In addition, the virtual device or the software technology is a type of distributing and managing software. This is to provide software and minimum system software (OS, file system, application server) necessary to operate the software to clients in a previously installed form by using a mobile storage device or wired/wireless communication.

In addition, there is a client/server based software streaming technology. The technology can generate the virtual environment and execute and use application programs as if the application programs were installed on the host computer. However, this is a technology capable of storing the actual application programs only in the storage device.

However, since the related arts are a general software distributing and managing technology, it is difficult for them to manage the plurality of application programs and the customized applications combined with add-on or plug-in and client information that can be combined with the plurality of application programs. Further, the related arts cannot restrict the editing function of the applications such that they have problems in security in companies that demand the security of information, and so on.

### SUMMARY OF THE INVENTION

An object of the present invention is to effectively manage customized applications according to characteristics of business, computer environment, and individual preference. Another object of the present invention is to execute and edits customized applications in a server (or virtual server on client) so as not to affect a system of a client terminal. Further, another object of the present invention is to be limited in accessing a client terminal system in applications and executing and editing applications in order to maintain security of applications and a client system.

An embodiment of the present invention provides an apparatus for managing customized applications, comprising: an application supplying unit that generates the customized applications by combining a plurality of pre-stored application data according to client information; an application executing unit (in a server or client terminal) that generates a virtual executing environment to make the customized applications be executed in a server(or virtual server on client) and supplies the virtual executing environment to the client terminal; and a filtering unit that controls whether it permits one or more of the execution and edition of the customized applications according to the client information.

The apparatus further comprise a storage unit that updates and stores the application data in real time according to the editing results by a client and supplies the application data to the application supplying unit.

The filtering unit may further comprise a system library filter that controls calling of system library function of the client terminal by the customized applications and returning of results of the calling, when executing the customized applications.

The system library filter permits the calling of the system library function to the customized applications only when preconditions for calling a function in the customized application at the time of calling the system library function is satisfied.

The system library filter transfers the results of the calling of the system library function to the client terminal only when postconditions for calling a function at the time of completing the system library function calling in the customized applications.

The customized applications may be divided into the plurality of application data included in the customized applications after the execution ends.

The application executing unit extracts one or more of a file, a registry, and a sharing component, included in the customized applications, which is necessary to execute the customized applications, and supplying them to the client terminal.

The application data includes one or more of a plurality of application programs, a file, a registry, and a sharing component necessary to execute the application program, an add-on or plug-in program combined in the application program, and the pre-stored customized applications.

The application supplying unit combines the application data based on configuration information of the customized applications for each client included in the client information.

The client information includes the configuration information of the application data for combining the customized applications and the execution and edition right information of the customized applications.

Another embodiment of the present invention provides a method for managing customized applications, comprising: generating the customized applications by combining a plurality of pre-stored application data according to client information, by an application supplying unit; generating a virtual executing environment to make customized applications b executed in a server and supplying the virtual executing environment to a client terminal by an application executing unit; and controlling whether or not to permit one or more of the execution and edition of the customized applications according to the client information by a filtering unit.

The additional configuration of the method for managing the customized applications is the same as the description of the apparatus for managing customized application.

According to the embodiments of the present invention, the apparatus and method for managing the customized applications have a capable of managing the application data in real time and immediately generate and make the use of the customized applications for each client according to the use request of the client terminal possible. As a result, the client can effectively use the applications specialized for each client in the mobile computing environment.

The customized applications are executed and edited in the server (or virtual server on client) through the virtual executing environment. Therefore, there is no need to install or remove the customized applications in and from the client terminal one by one.

The customized application may be generated which comprise the application executing unit and transmitted to the client terminal In that case, the customized application will be copied and executed by “click and run method” in the client terminal. The customized application can be easily removed by deleting files.

In addition, because the customized application comprising the application executing unit can also perform as a virtual server, the customized application can be executed in the client terminal even though the network connection with the server is disconnected. As a result, it can increase the stability of the client terminal system.

In addition, the control of the execution and edition of the customized application is made based on the client information. Therefore, the present invention can solve the problem of security that may be generated due to the random change of the customized applications. Similar to this, the present invention permits the access to the system library function of the client terminal in the customized applications only when it satisfies preconditions and postconditions for calling the function, thereby making it possible to improve the security of the client terminal.

### BRIEF DESCRIPTION OF THE DRAWINGS

FIG. 1 is a block diagram of an apparatus for managing customized applications according to an embodiment of the present invention;

FIG. 2 is a diagram schematically showing an example of an execution of customized applications;

FIG. 3 is a block diagram showing a detailed configuration of a filtering unit;

FIG. 4 is a block diagram showing a function of a filtering unit of controlling access to applications;

FIG. 5 is block diagram showing a function of a system library filter for controlling access to a system library;

FIG. 6 is a flowchart of a method for managing customized applications according to an embodiment of the present invention; and

FIG. 7 is a flowchart showing a function of a system library filter.

### DETAILED DESCRIPTION OF THE PREFERRED EMBODIMENTS

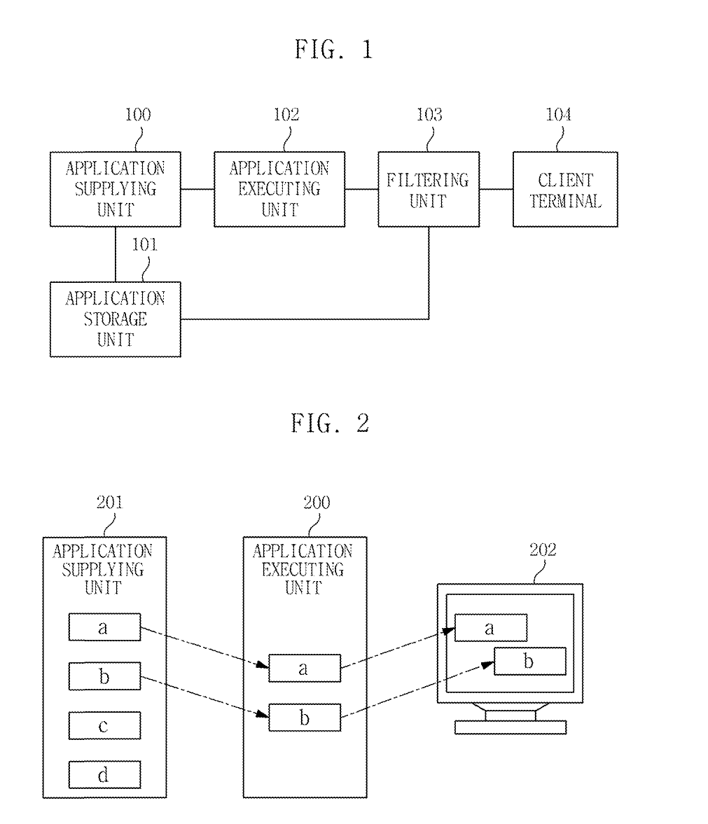

Hereinafter, an apparatus for managing customized applications according to an embodiment of the present invention will be described with reference to FIG. 1.

FIG. 1 is a block diagram of an apparatus for managing customized applications according to an embodiment of the present invention.

Referring to FIG. 1, an apparatus for managing customized applications according to an embodiment of the present invention comprises an application supplying unit 100, an application executing unit 102, and a filtering unit 103. In addition, the apparatus may comprise an application storage unit 101 and may be connected to a client terminal 104.

The application supplying unit 100 combines a plurality of pre-stored application data according to client information to perform a function of generating customized applications.

The application supplying unit 100 receives the use request for the customized applications from the client terminal 104. When the use request is received, the customized applications are generated by extracting the plurality of application data included in the use requested customized application from a client terminal 104 and combining the extracted application data.

The generated customized applications are transferred to the application executing unit 102, which is usable in the client terminal 104 through a virtual execution environment.

Therefore, the application supplying unit 100 may further have a function of storing the plurality of application data. Therefore, the application supplying unit 100 may have a database storing the application data according to a type of application data.

Alternatively, the application supplying unit 100 may perform only the function of generating and supplying the customized applications through the combination of application data. In this case, there may be the application storage unit 101 that is the additional component described above. The database described above may exist in the application storage unit 101.

In the embodiment of the present invention, the plurality of application data includes all the data for generating the customized applications.

For example, the application data may include the plurality of application programs. The application programs mean the basic application that can perform a predetermined function and can be executed through an operation system (OS). These programs mean programs produced so that individuals or groups (for example, enterprise) can generally use a function of processing words, adjusting accounting, and analyzing a technique.

The application data may include files, registries, and sharing components needed to execute application programs. The file needed to execute the application program may include a guest OS or a driver file. The registry and sharing component include all information that may be included in the above-mentioned information of application data, sharing information of application programs, registry, and sharing component, all of which are connected to application programs.

The application data may include an add-on or plug-in programs that may be combined to application programs. The add-on or plug-in program means a program that expands or changes the functions to meet the basic application program to the specific purpose. For example, a program that can combine the technical analyzing program with the word processing program and use it or a program that enables additional functions to use application programs according to right information (for example, location, time, user) may be included in the add-on or the plug-in program. In addition to this, it may include the generally known add-on or plug in program.

The application data may also include the pre-stored customized applications. For example, when the enterprise wants to use and distributes one customized application continuously, there is no need to generate customized applications every time when there is a request of the client terminal 104 from the application supplying unit 100. In this case, the efficiency of the distribution and use of the customized application may be increased by using the pre-stored customized applications.

The client information used to generate the customized application may include the configuration information of the application data for combining the customized application. The add-on or plug-in program to be combined with the specific applications may be various for each client. Therefore, when the configuration information of the application data to be combined for each client is transferred from the client terminal 104 at the time of requesting the use of the customized application, the application supplying unit 100 extracts and combines the application data according to the configuration information received from the client terminal 104.

The present invention can effectively manage the customized applications specialized for each client by using the client information to generate the customized application. That is, the customized applications are immediately combined according to the client information. Alternatively, when the customized application corresponding to the client information is pre-stored, the customized applications are simply uploaded. As a result, the present invention can manage the customized applications to effectively take an action various demands for each client.

The application executing unit 102 performs a function of generating the virtual execution environment and supplying it to the client terminal 104 so that the customized applications are executed in the server (or virtual server on client).

In the embodiment of the present invention, the server includes the apparatus for managing the customized applications according to the embodiment of the present invention and includes all the apparatuses that supply information through the transmission and reception to and from the client terminal 104. That is, the server may mean the communication subject other than the client terminal 104. For example, the server of the communication company, the server of internet supplying company, the communication server of a company, etc., may be included in the server according to the embodiment of the present invention.

Therefore, the function of a virtual executing environment generated in the application executing unit 102 is to show as if the customized applications which are actually executed in a server (or virtual server on client terminal 104) were executed in the client terminal 104.

Therefore, the virtual executing environment is built by transmitting only the minimum files to the client terminal 104 to show as if the customized applications were executed in the client terminal 104. Therefore, the fact that the application executing unit 102 generates the virtual executing environment and supplies it to the client terminal 104 means that only the minimum file is supplied to show as if the customized applications were executed in the client terminal 104.

The file supplied by the application executing unit 102 in order to build the virtual executing environment in the client terminal 104 may include a file necessary to execute the customized applications. The file necessary to execute the customized applications may be a guest operation system that are compatible with an operation system installed in the client terminal 104 and enables the execution of the customized applications and an execution file of the customized applications. In addition, the registry and the sharing component of the customized applications may be included as a file that can execute and use the customized applications according to the execution file.

The application executing unit 102 receives the customized applications generated by the application supplying unit 100 and supplies the file for building the above-mentioned virtual executing environment to the client terminal 104. Therefore, even though the customized applications are executed in the client terminal 104, the customized applications are actually operated in the application executing unit 102, that is, the server, which does not have an effect on the system of the client terminal 104.

The application executing unit 102 exists in the server, transmits and manages execution information of the customized application with connected with the client terminal 104.

The customized application may be generated which comprise the application executing unit 102 and transmitted to the client terminal 104. In that case, the customized application will be copied and executed by “click and run method” in the client terminal 104. The customized application can be easily removed by deleting files.

In addition, because the customized application comprising the application executing unit 102 can also perform as a virtual server, the customized application can be executed in the client terminal 104 even though the network connection with the server is disconnected. As a result, it can increase the stability of the client terminal system.

Therefore, it can overcome the instability of the system of the client terminal 104 by frequently deleting and installing the applications.

In the embodiment of the present invention, when the execution of the customized applications ends in the client terminal 104, the customized applications may be divided and stored again into the plurality of application data included in the customized applications. If the customized applications are stored as it is without being divided and stored into the plurality of application data, the amount of data stored in the application supplying unit 100 or the application storage unit 101 may be rapidly increased. In order to minimize the overload of the system or the storage capacity, after the execution of the customized applications ends, it may be divided again into application data before combining.

Further, when the edition right of the application is allocated according to the client, the client can select whether or not to divide and manage the customized application again or store the generated customized application as it is.

The filtering unit 103 performs a function of controlling whether any one of the execution and edition of the customized applications is permitted according to the client information.

First, when the client terminal 104 receives the request of using of the specific customized applications, the filtering unit 103 receives the client information together.

Therefore, the client information in the embodiment of the present invention may include the information on the execution and edition right of the customized applications in addition to the configuration information of the application data for combining the above-mentioned customized applications.

The execution right information of the customized applications generally means the rights information used in a digital right management (DRM) technology. In other word, an example thereof may include the execution restriction, the restriction of the used time, and the restriction of the used location according to the client and the execution restriction according to the terminal The execution of the customized applications is controlled according to the execution right information included in the client information, thereby making it possible to effectively manage the customized applications while improving the security for the specially used customized application according to the purpose.

The edition rights information of the customized applications is information controlling the indiscreet edition of the customized applications, in addition to the rights capable of selecting whether the customized applications are kept after the above-mentioned execution ends.

For example, when the plurality of application data are combined in one application program, the specialized customized applications should be generated by combining only the specific application data for each company. In addition, when the add-on or the plug-in combined in the customized applications is needed to secure the information on companies, there is a need to restrict the edition of the customized applications.

Therefore, the edition rights information of the customized applications is set in the client information. For example, the manager and the user are sorted for each client, such that the manager can hold the edition rights of the customized applications and the user can delete the edition right of the customized applications. Through this, the random edition and change of the customized applications can be restricted.

Therefore, the filtering unit 103 may comprise a filter that restricts access to the customized application in order perform the above-mentioned functions. In the embodiment of the present invention, the filtering unit 103 means a filter to limit access to the customized applications.

The apparatus for managing customized applications according to the exemplary embodiment of the present invention may further comprise an application storage unit 101. The application storage unit 101 serves to store the plurality of application data as described above.

Since the client having the edition rights can edit the customized applications, the plurality of application data stored in the application storage unit 101 can be changed. Therefore, the application storage unit 101 may have a function of updating the application data in real time according to the editing result of the client and storing them. In addition, the application storage unit 101 may have a function of supplying the application data to the application supplying unit 100.

FIG. 2 is a diagram schematically showing an example of an execution of customized applications. The description of the repeated portions with the description of FIG. 1 will be omitted in the following description.

Referring to FIG. 2, an application supplying unit 201 selects and combines one or more of the application data(a and be of a, b, c, and d) in order to combine the customized applications according to the request of the client from the data base or the application storage unit (not shown). The customized applications(a and b) generated by combining the selected application data(a and b) are used in the client terminal 202. In this case, it looks like that the customized applications are actually executed in the application execution unit 200 and in the client terminal 202.

The customized applications comprising application execution unit 200 can be copied to the client terminal 202 and executed in the client terminal 202. The client terminal 202 can execute customized applications independently from the server with support of application execution unit 200 in virtual server.

In the embodiment of the present invention, there is the filter unit (not shown) between the application executing unit 200 and the client terminal 202, such that the execution and edition of the customized applications can be restricted based on the client information.

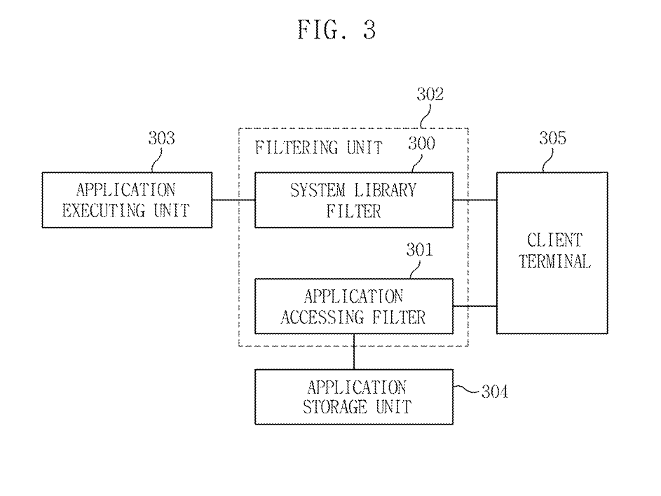

FIG. 3 is a block diagram showing a detailed configuration of a filtering unit. The description of the repeated portions with the description of FIGS. 1 and 2 will be omitted in the following description.

Referring to FIG. 3, a filtering unit 302 comprises a system library filter 300 and an application accessing filter 301. As described above, in the embodiment, the application accessing filter 301 has the same meanings as the filtering unit 302. However, in another embodiment of the present invention, the filter unit 302 may further comprise the system library filter 300.

The system library filter 300 is connected to the application executing unit 303 and the client terminal 305. The system library filter 300 controls the calling of one or more function stored in the system library by accessing the customized application to the client terminal 305. The application accessing filter 301 performs the same function as the above-mentioned filter unit 103 as described with reference to FIG. 1.

In FIG. 3, the plurality of application data are stored in the application storage unit 304. Therefore, the application accessing filter 301 is connected to the application storage unit 304 to issue a command that supplies the application data for the customized application combination to the application supplying unit according to the client information.

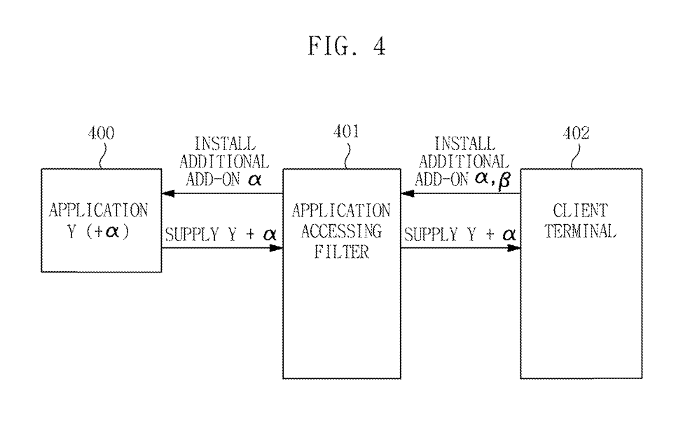

FIG. 4 is a block diagram showing a function of a filtering unit of controlling access to the filtering unit controlling application. The description of the repeated portion with the description of FIGS. 1 to 3 will be omitted in the following description.

Referring to FIG. 4, it commands installing α and β with an additional add-on to an application Y 400 in the client terminal 402. In this case, the application accessing filter 401 analyzes the edition rights of the application Y 400 based on the client information. As the analysis result, it is determined that the add-on β is not installed and it issues a command to install only the add-on α in the application Y 400 and is provided to use the customized applications of Y+α in the client terminal 402.

FIG. 4 shows the case where the customized application Y+α is supplied directly; however, it may be actually executed in the application executing unit (not shown) as described above.

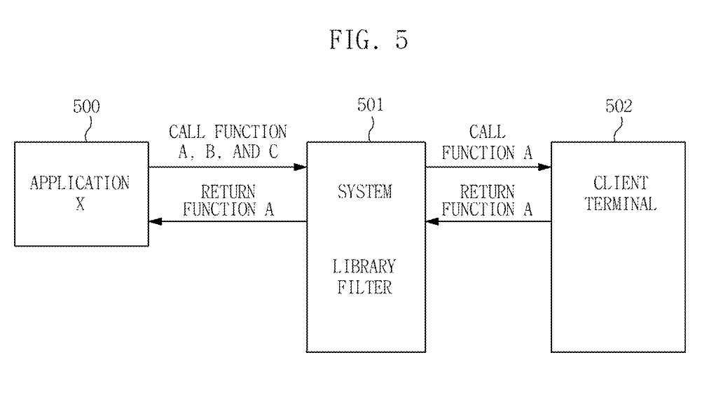

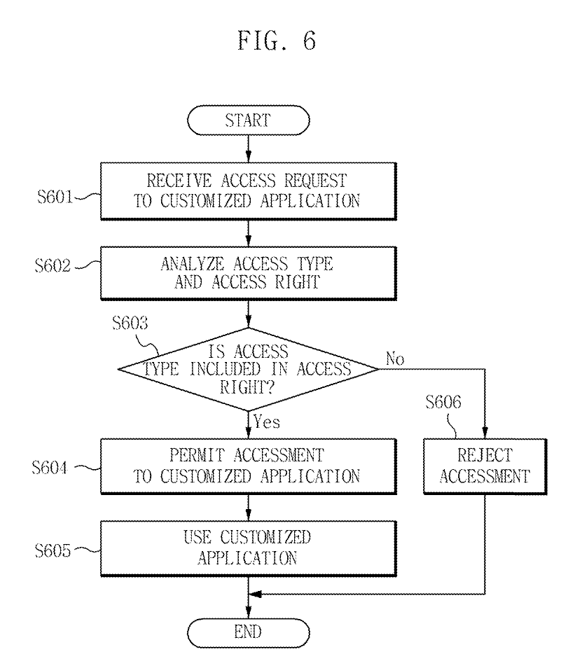

FIG. 5 is block diagram showing a function of a system library filter for controlling access to a system library. The description of the repeated portion with the description of FIGS. 1 to 4 will be omitted in the following description.

Referring to FIG. 5, the system library filter 501 controls customized application X 500 to access to the client terminal unlike the application accessing filter. Although the customized application X 500 is installed and executed in the server, the case where it calls the system library function of the client terminal 502 according to the operation may occur. In this case, the system library filter 501 controls whether it calls the system library function stored in the client terminal 502.

The system library filter 501 performs the following functions in detail. First, when the application X 500 wants to call the system library functions a, b, and c existing in the client terminal 502, the system library filter 501 determines whether it satisfies precondition for calling the function of the system library functions a, b, and c based on the execution process of the application X 500.

For example, it is assumed that the functions a, b, and c mean the directory generating function of a different system library. It is assumed that the application X 500 can generate the directory only for the specific system library of the client terminal 502. In this case, when only the function a satisfies the conditions, the function b and c do not meet the conditions before calling the system library function, such that the system library filter 501 calls only the function a from the client terminal 502.

In addition, the system library filter 501 may further have a function of performing a control to return the execution result of the function a of the application X 500, that is, the call results of the system library function a of the client terminal 502. In this case, the system library filter 501 determines whether it satisfies the postconditions calling the system library function to return the function calling result to the customized applications.

For example, the function a is called. The calling result of the function generates the directory of the specific system library. Therefore, the conditions after calling the function may be whether the directory is normally generated. If the directory is not normally generated due to the lack of the storage capacity, it does not meet the conditions after calling the function a, such that the calling result of the function ‘a’ is not returned. To the contrary, when the directory is normally generated, the calling result of the function is returned by determining that it satisfies the conditions of the number of calls of the function a.

The system library filter 501 can control the indiscreet access to the client terminal 502 of the specific customized applications through the above-mentioned function. Therefore, in the customized applications accessing the system library which may be the business secret, the call for the system library function is restricted based on the specific conditions, thereby making it possible to randomly leak the business secret. Thereby, the present invention can improve the security.

FIG. 6 is a flowchart of a method for managing customized applications according to an exemplary embodiment of the present invention. The description of the repeated portion with the description of FIGS. 1 to 5 will be omitted in the following description.

Referring to FIG. 6, the method for managing the customized applications according to the exemplary embodiment of the present invention depends on the following progress.

First, the request of the execution and edition (hereinafter, accessing the customized applications) of the customized applications from the client terminal is received by the filter unit (S601). The filtering unit analyzes the access request of the client terminal and the client information to perform analyzing the access type and access right to the customized applications (S602) and performs determining (S603) whether the access type is included in the access right.

When the access type (that is, execution or edition) requested by the client is included in the access right, the filtering unit performs permission of access to the customized application (S604). A step (S605) of using the customized applications is performed by the client terminal On the other hand, when the access type requested by the client is not included in the access right, the filtering unit performs rejection of access to the customized applications (S606).

At step S605, a series of steps that supplies the virtual executing environment capable of using the customized applications to the client terminal is performed based on the execution or edition of the customized applications of the client.

In other words, step S605 performs generating the customized applications by allowing the application supplying unit to combine the plurality of application data according to the client information and generating the virtual executing environment to allow the application executing unit to execute the customize applications in the server and supplying it to the client terminal.

The description of the additional function (or performing the function) the above-mentioned application supplying unit and the application execution unit and the filtering unit is the same as the description of FIGS. 1 to 5.

In addition, the embodiment of the present invention may further include allowing the application storage unit to update and store the application data in real time according to the editing result of the client and supplying the application data to the application supplying unit in addition to all the steps performed in FIG. 6.

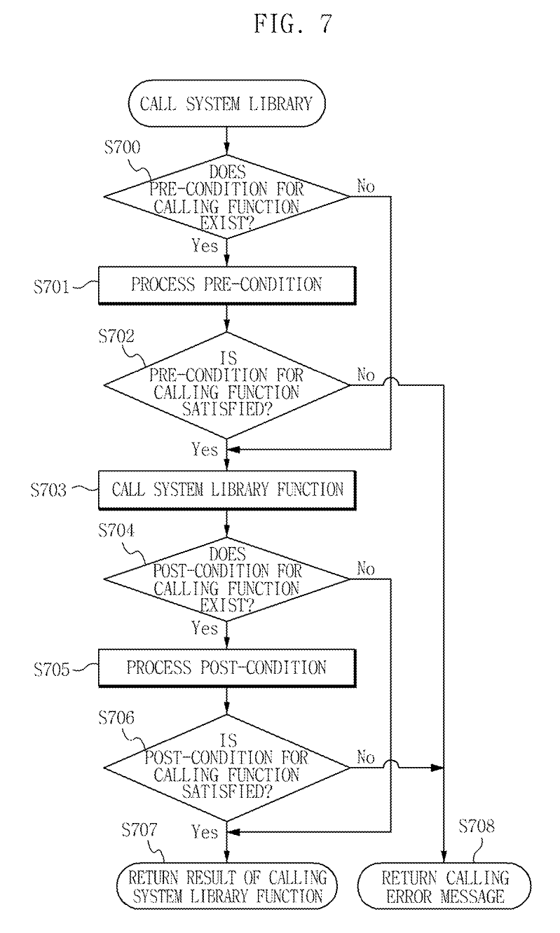

FIG. 7 is a flowchart showing a function of a system library filter. The description of the repeated portion with the description of FIGS. 1 to 6 will be omitted in the following description.

Referring to FIG. 7, the system library filter performs the following functions when the customized application calls the system library function of the client terminal

First, the system library filter performs determining whether it satisfies the preconditions to call the system library function (S700). If it is determined that there is the preconditions, a step (S701) of processing the preconditions is performed when the preconditions for the function calling can be processed.

After performing step S701, the system library filter performs a step of determining whether it satisfies the pre-conditions to call the system library function (S702). If it is determined that it satisfies the conditions before calling the functions or that it does not satisfy the conditions before calling the function, the system library filter performs a step of permitting the customized applications to call the system library function (S703).

If it is determined that it does not satisfy the preconditions for calling the function, a step of returning the error message for the function calling while the customized applications are executed is performed (S708).

When calling the system library function, the system library filter determines whether there are the postconditions for the function calling (S704) to perform a step of processing the postconditions when there are the postconditions for calling the function is performed (S705). Thereafter, the system library filter performs determining whether it satisfies the postconditions for calling the system library function (S706).

If it is determined that it satisfies the postconditions for calling the function, a step of returning the results of calling the system library function while the execution of the customized applications progresses (S707). If it is determined that it does not satisfy the postconditions for calling the function, the error message is returned by performing step S708.

While the present invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. An apparatus for managing customized applications, comprising:
an application supplying unit that generates the customized applications by combining a plurality of pre-stored application data according to client information;
an application executing unit that generates a virtual executing environment to make the customized applications executed in a server or a virtual server on a client terminal and supplies the virtual executing environment to a client terminal; and
a filtering unit that controls whether or not to permit one or more of the execution and edition of the customized applications, according to the client information.

2. The apparatus of claim 1, further comprising an application storage unit that updates and stores the application data in real time according to the editing results by a client and supplies the application data to the application supplying unit.

3. The apparatus of claim 1, wherein the filtering unit further comprises a system library filter that controls calling of system library function of the client terminal by the customized applications and returning results of the calling, when executing the customized applications.

4. The apparatus of claim 3, wherein the system library filter permits the calling of the system library function to the customized applications only when preconditions for calling a function in the customized application at the time of calling the system library function is satisfied.

5. The apparatus of claim 3, wherein the system library filter transfers the results of the calling of the system library function to the client terminal only when postconditions for calling a function at the time of completing the system library function calling in the customized applications.

6. The apparatus of claim 1, wherein the customized applications is divided into the plurality of application data included in the customized applications after the execution ends.

7. The apparatus of claim 1, wherein the application executing unit extracts one or more of a file, a registry, and a sharing component, included in the customized applications, which is necessary to execute the customized applications, and supplies to the client terminal, or is combined to the customized application and transmitted to the client terminal.

8. The apparatus of claim 1, wherein the application data includes one or more of a plurality of application programs, a file, a registry, and a sharing component necessary to execute the application program, an add-on or plug-in program combined in the application program, and the pre-stored customized applications.

9. The apparatus of claim 1, wherein the application supplying unit combines the application data based on a configuration information of the customized applications for each client included in the client information.

10. The apparatus of claim 1, wherein the client information includes the configuration information of the application data for combining the customized applications and the execution and edition right information of the customized applications.

11. A method for managing customized applications, comprising:
generating the customized applications by combining a plurality of pre-stored application data according to client information, by an application supplying unit;
generating a virtual executing environment to make the customized applications executed in a server or a virtual server on a client terminal and supplying the virtual executing environment to a client terminal by an application executing unit; and
controlling whether or not to permit one or more of the execution and edition of the customized applications, according to the client information by a filtering unit.

12. The method of claim 11, further comprising updating and storing the application data in real time according to the editing results by a client and supplies the application data to the application supplying unit by an application storage unit.

13. The method of claim 11, further comprising controlling calling of system library function of the client terminal by the customized application; and
returning results of the calling by a system library filter when executing the customized applications.

14. The method of claim 13, the controlling the calling and the returning the results is permitting the calling of the system library function to the customized applications only when preconditions for calling a function in the customized application at the time of calling the system library function is satisfied.

15. The method of claim 13, wherein the controlling the calling and the returning the results is transferring the results of the calling of the system library function to the client terminal only when postconditions for calling a function at the time of completing the system library function calling in the customized applications.

16. The method of claim 11, wherein the customized applications is divided into the plurality of application data included in the customized applications after the execution ends.

17. The method of claim 11, wherein the generating the virtual executing environment and the supplying the virtual executing environment is extracting one or more of a file, a registry, and a sharing component, included in the customized applications, which is necessary to execute the customized applications, and supplies to the client terminal or is combined to the customized application and transmitted to the client terminal by the application executing unit.

18. The method of claim 11, wherein the application data includes one or more of a plurality of application programs, a file, a registry, and a sharing component necessary to execute the application program, an add-on or plug-in program combined in the application program, and the pre-stored customized applications.

19. The method of claim 11, wherein the generating the customized applications combines the application data based on the configuration information of the customized applications for each client included in the client information.

20. The method of claim 11, wherein the client information includes the configuration information of the application data for combining the customized applications and the execution and edition right information of the customized applications.
